(19) United States
(12) Patent Application Publication
(10) Pub. No.: US 2011/0195658 A1
(43) Pub. Date: Aug. 11, 2011

(54) LAYERED RETRANSMISSION APPARATUS AND METHOD, RECEPTION APPARATUS AND RECEPTION METHOD

(75) Inventors: Seong Rag Kim, Daejeon (KR); Seuck Ho Won, Daejeon (KR); Jung-Im Kim, Daejeon (KR)

(73) Assignee: Electronics and Telecommunications Research Institute, Daejeon (KR)

(21) Appl. No.: 13/025,742

(22) Filed: Feb. 11, 2011

(30) Foreign Application Priority Data
Feb. 11, 2010 (KR) 10-2010-0012700
Mar. 29, 2010 (KR) 10-2010-0027928
Mar. 29, 2010 (KR) 10-2010-0027929
Mar. 29, 2010 (KR) 10-2010-0027931
Feb. 10, 2011 (KR) 10-2011-0011880

(51) Int. Cl. H04B 7/14; H04B 3/36

(52) U.S. Cl. 455/7; 375/211

(57) ABSTRACT

A retransmission apparatus for retransmitting information received from a base station to a reception apparatus includes: a reception unit configured to receive information regarding a plurality of layers from the base station; determining unit configured to determine retransmission control information including at least one layer to be retransmitted among the plurality of layers based on feedback information received from the reception apparatus; and a transmission unit configured to retransmit the at least one layer information to the reception apparatus based on the results of the determining unit.

### CROSS-REFERENCE TO RELATED APPLICATION

This application claims priority to and the benefit of Korean Patent Application No. 10-2010-0012700, 10-2010-0027931, 10-2010-0027929, 10-2010-0027928 and 10-2011-0011880 filed in the Korean Intellectual Property Office on Feb. 11, 2010, Mar. 29, 2010, Mar. 29, 2010, Mar. 29, 2010 and Feb. 10, 2011, the entire contents of which are incorporated herein by reference.

### BACKGROUND OF THE INVENTION

(a) Field of the Invention

The present invention relates to a layered retransmission apparatus and method, a reception apparatus, and a reception method.

(b) Description of the Related Art

A broadcasting system, providing diverse video qualities, transmits scalable video coded image information so as to be compatible with receiving apparatuses having various performances. A scalable video coding (SVC) is classifying information into a plurality of layers according to the significance of image information and transmitting the same. When a transmitter performs layered transmission to effectively transmit image information using the SVC technique, a receiver reproduces the layers according to desired image quality or device performance. However, the coverage is narrow because a base station simultaneously transmits a plurality of layer information through the layered transmission. Thus, in an effort to solve this problem, a retransmission apparatus including a relay station retransmits a signal received from the base station to thus extend the coverage. However, because the retransmission apparatus hitherto uses the same frequency band with that of the base station and retransmits the received signals as it is, a great amount of transmission power is consumed.

### SUMMARY OF THE INVENTION

The present invention has been made in an effort to provide a layered retransmission apparatus and method for determining a layer requested to be retransmitted and transmission power of each layer based on feedback information from a reception apparatus and performing retransmission, and also provide a reception apparatus and reception method for receiving signals transmitted from a base station and a retransmission apparatus and decoding the received signals.

An exemplary embodiment of the present invention provides a retransmission apparatus for retransmitting information received from a base station to a reception apparatus, including: a reception unit configured to receive information regarding a plurality of layers from the base station; determining unit configured to determine retransmission control information including at least one layer to be retransmitted among the plurality of layers based on feedback information received from the reception apparatus; and a transmission unit configured to retransmit the at least one layer information to the reception apparatus based on the results of the determining unit.

The determining unit may determine the retransmission control information based on the feedback information including layer information requested to be retransmitted.

When it is determined to retransmit some of a plurality of layers, the transmission unit may retransmit information regarding some of the layers to the reception apparatus in a transmission slot (or a transmission slot) different from a slot in which the information regarding the plurality of layers is received from the base station.

When it is determined to retransmit the plurality of layers, the transmission unit may retransmit the information regarding the plurality of layers to the reception apparatus in the same transmission slot in which the information regarding the plurality of layers is received from the base station.

The retransmission control information may include transmission power of the layer to be retransmitted.

When it is determined to change transmission power of the layer to be retransmitted, the transmission unit may retransmit the information regarding the layer to be retransmitted to the reception apparatus in a transmission slot different from a slot in which the information regarding the plurality of layers is received from the base station.

The retransmission apparatus may further include: a retransmission control information transmission unit configured to transmit the retransmission control information to the reception apparatus before retransmitting the at least one layer information to the reception apparatus.

Another embodiment of the present invention provides a reception apparatus for receiving information regarding a plurality of layers from a base station and receiving at least one of layer information among the plurality of layers from a retransmission apparatus, including: a transceiver unit configured to transmit feedback information related to a retransmission of the plurality of layers to the retransmission apparatus and receive retransmission control information from the retransmission apparatus; a symbol metric estimation unit configured to estimate symbol metrics transmitted from the base station and the retransmission apparatus based on the retransmission control information; a plurality of bit metric calculation units configured to determine bit metrics of a corresponding layer among the plurality of corresponding layers based on the estimated symbol metrics; and a decoding unit configured to decode an information bit of the corresponding layer based on the bit metrics of the corresponding layer.

The retransmission control information may include a layer to be retransmitted by the retransmission apparatus and transmission power of the layer to be retransmitted.

When the retransmission control information includes information indicating that the plurality of layers are retransmitted, the symbol metric estimation unit may estimate symbol metrics based on channel information obtained by adding channel information of the base station and that of the retransmission apparatus.

When the retransmission control information includes information indicating a signal different from that of the base station is retransmitted, the symbol metric estimation unit may estimate the symbol metrics transmitted from the base station and the retransmission apparatus based on the channel information of the base station and that of the retransmission apparatus, respectively.

The transceiver unit may receive the retransmission control information including at least one of information indicating that some of the plurality of layers are retransmitted and information indicating that a layer with changed transmission power is retransmitted.

Each of the bit metric calculation unit may include: a calculation unit configured to calculate a first bit metric transmitted from the base station and a second bit metric transmitted from the retransmission apparatus based on the estimated symbol metrics; and a selection unit configured to determine any one of the first and second bit metrics as a bit metric of the corresponding layer based on the reliability of the first and second bit metrics when the base station and the retransmission apparatus transmit the same layer information.

Yet another embodiment of the present invention provides a method for retransmitting information received from a base station to a reception apparatus by a retransmission apparatus, including: receiving information regarding a plurality of layers from the base station; determining retransmission control information including at least one layer to be transmitted among the plurality of layers based on feedback information received from the reception apparatus; and selecting a transmission scheme based on the retransmission control information and retransmitting the at least one layer information to the reception apparatus.

In the determining of the retransmission control information, the retransmission control information may be determined based on the feedback information including layer information requested to be retransmitted.

The retransmission control information may include transmission power of the layer to be retransmitted.

In the retransmitting, when it is determined to retransmit some of the plurality of layers, the information regarding some of the layers may be retransmitted in a transmission slot different from a slot in which the information regarding the plurality of layers is received from the base station, when it is determined to retransmit the plurality of layers, the information regarding the plurality of layers may be retransmitted in the same slot as the transmission slot in which the information regarding the plurality of layers is received from the base station, and when it is determined to change transmission power of the layer to be retransmitted, the information regarding the layer to be retransmitted may be retransmitted in the transmission slot different from a slot in which the information regarding the plurality of layers is received from the base station.

Still another embodiment of the present invention provides a method for receiving information regarding a plurality of layers from a base station and at least one layer information among the plurality of layers from a retransmission apparatus by a reception apparatus, including: transmitting feedback information related to a retransmission of the plurality of layers to the retransmission apparatus and receiving retransmission control information including a layer to be retransmitted and transmission power of the layer to be retransmitted from the retransmission apparatus; estimating symbol metrics transmitted from the base station and the retransmission apparatus based on the retransmission control information; determining bit metric of a corresponding layer among the plurality of layers based on the estimated symbol metric; and decoding an information bit of the corresponding layer based on the bit metric of the corresponding layer.

In the estimating of the symbol metrics, when the retransmission control information includes information indicating that a signal different from that of the base station is retransmitted, the respective symbol metrics transmitted from the base station and the retransmission apparatus may be estimated based on channel information of the base station and that of the retransmission apparatus.

The determining of the bit metrics may include: calculating a first bit metric transmitted from the base station and a second bit metric transmitted from the retransmission apparatus based on the estimated symbol metrics; and when the base station and the retransmission apparatus transmit the same layer information, selecting any one of the first and second bit metrics, as the bit metric of the corresponding layer based on the reliability of the first and second bit metrics.

According to embodiments of the present invention, because the retransmission apparatus retransmits some of layers according to the situation of the reception apparatus, power consumption can be reduced. In addition, the retransmission apparatus can separately change coverage of each layer by adjusting transmission power of each layer and reduce power consumption. Also, because the reception apparatus receives a layer required to be retransmitted from the retransmission apparatus, the reception apparatus can effectively decode it.

### BRIEF DESCRIPTION OF THE DRAWINGS

FIG. 1 is a view illustrating a block diagram of a retransmission system according to an exemplary embodiment of the present invention.

FIG. 2 is a schematic block diagram of a retransmission apparatus according to an exemplary embodiment of the present invention.

FIG. 3 is a view illustrating a transmission unit of the retransmission apparatus according to an exemplary embodiment of the present invention.

FIG. 4 is a view illustrating a reception apparatus according to an exemplary embodiment of the present invention.

FIG. 5 is a flow chart illustrating the process of a retransmission method according to an exemplary embodiment of the present invention.

FIG. 6 is a flow chart illustrating the process of a reception method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

A transmission apparatus, a retransmission method, a reception apparatus, and a reception method according to exemplary embodiments of the present invention will now be described in detail with reference to the accompanying drawings.

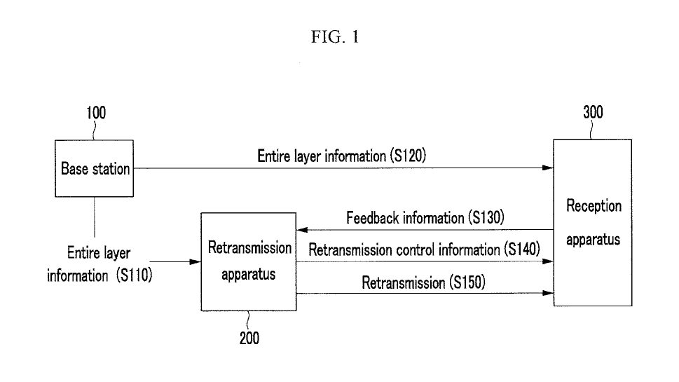

FIG. 1 is a view illustrating a block diagram of a retransmission system according to an exemplary embodiment of the present invention.

With reference to FIG. 1, a retransmission system includes a base station 100, a retransmission apparatus 200, and a reception apparatus 300.

The base station 100 performs scalable video coding (SVC) on image information into a plurality of layers including a base layer and an enhancement layer and transmits the scalable-video-coded layers to the retransmission apparatus 200 and the reception apparatus 300 (S110 and S120). In this case, the base station 100 transmits full layer information.

The retransmission apparatus 200 receives the full layer information through a wired or wireless communication network from the base station 100 (S110). The retransmission apparatus 200 receives feedback information from the reception apparatus 300 (S130) and determines at least one layer to be retransmitted and transmission power of the layer to be retransmitted. The retransmission apparatus 200 transmits retransmission control information including the layer to be retransmitted and the transmission power to the layer to be retransmitted to the receiving apparatus 300 (S140). The retransmission apparatus 200 retransmits the layer, whose gain has been controlled according to the determined transmission power, to the reception apparatus 300 (S150). When the retransmission apparatus 200 retransmits a plurality of layers, which have been received from the base station 100 as it is, it may retransmit the plurality of layers at the interval at which the plurality of layers are received. When the retransmission apparatus 200 retransmits some of the plurality of layers or retransmits the layers after adjusting transmission power, the retransmission apparatus 200 may retransmit the layers at an interval different from the interval at which the plurality of layers are received from the base station 100.

The reception apparatus 300 receives information regarding the plurality of layers from the base station 100. In this case, when some of the plurality of layers are required to be retransmitted, the reception apparatus 300 transmits feedback information requesting retransmission to the retransmission apparatus 200 (S130). Thereafter, the reception apparatus 300 receives retransmission control information and at least one retransmitted layer information from the retransmission apparatus 200. In this case, when the reception apparatus 300 receives the same layer information from the base station 100 and the retransmission apparatus 200, the reception apparatus 300 discriminates reliability of the layer information transmitted by the base station 100 and that of the retransmission apparatus 200 to select one layer information among them.

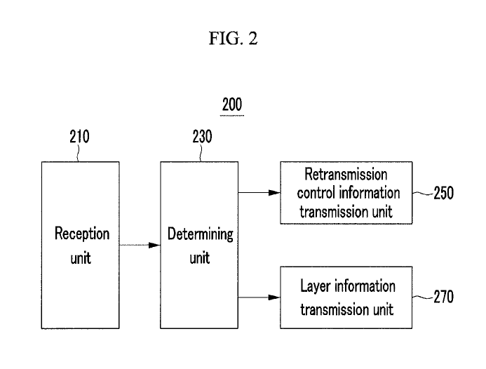

FIG. 2 is a schematic block diagram of a retransmission apparatus according to an exemplary embodiment of the present invention.

With reference to FIG. 2, the retransmission apparatus 200 includes a reception unit 210, a determining unit 230 for determining retransmission control information, a retransmission control information transmission unit 250, and a layer information transmission unit 270 for retransmitting layer information based on the results from the determining unit 230.

The reception unit 210 receives information regarding a plurality of layers from the base station 100 and also receives feedback information from the reception apparatus 300.

The determining unit 230 determines retransmission control information including information regarding a layer to be retransmitted based on the received feedback information. Also, the determining unit 230 may control transmission power, namely, the gain, of the layer to be retransmitted. In this case, the feedback information includes the information regarding the layer requested to be retransmitted, and the retransmission control information includes the information regarding the layer to be retransmitted and transmission power of the layer to be retransmitted. The determining unit 230 may determine to retransmit the signal, which has been received from the base station 100, as it is, or determine to retransmit a signal different from the signal which has been received from the base station. In this case, the different signal may be a signal transmitting only a portion of the layers which have been transmitted by the base station 100, or a signal having changed transmission power. The retransmission control information transmission unit 250 transmits the retransmission control information to the reception apparatus 300. In this case, the retransmission control information transmission unit 250 transmits the retransmission control information before the layer information transmission unit 270 retransmits layer information.

In case in which the layer information transmission unit 270 retransmits all the layer information, which has been received from the base station 100, as it is without changing transmission power, it may retransmit all the layer information while receiving the same from the base station 100. In this case, when the transmission between the base station 100 and the retransmission apparatus 200 is wireless communication, the layer information transmission unit 270 may retransmit the layer information in full-duplexing communication. Then, the reception apparatus 300 simultaneously receives signals from the base station 100 and the retransmission apparatus 200 and obtains a diversity gain. When the layer information transmission unit 270 retransmits layer information by adjusting transmission power or retransmits some of the layers, it may differentiate a transmission slot (or a transmission section) through time division or frequency division. That is, the layer information transmission unit 270 may not retransmit layer information to the reception apparatus 300 when the base station 100 transmits full layer information. For example, the layer information transmission unit 270 may use a transmission slot for communication between the retransmission apparatus 200 and the reception apparatus 300, that the transmission slot is divided into a slot for communication between the base station 100 and the retransmission apparatus 200 and a slot for communication between the retransmission apparatus 200 and the reception apparatus 300 for half-duplex. As the number of retransmission layers is small, the transmission slot between the retransmission apparatus 200 and the reception apparatus 300 is short.

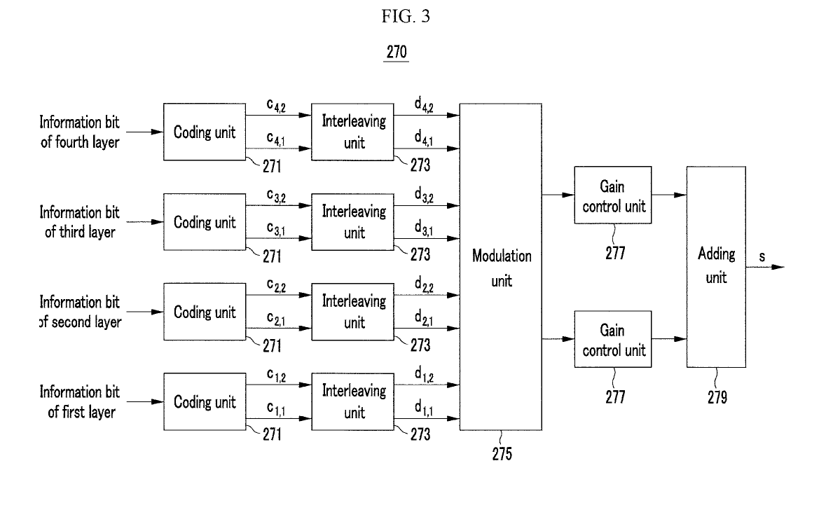

FIG. 3 is a view illustrating a transmission unit of the retransmission apparatus according to an exemplary embodiment of the present invention.

With reference to FIG. 3, the layer information transmission unit 270 includes a plurality of coding units 271, a plurality of interleaving units 273, a modulation unit 275, a plurality of gain control units 277, and an adding unit 279. The plurality of coding units 271 correspond to each of the plurality of layers, and each of the coding units 271 codes an information bit of a corresponding layer. The plurality of interleaving units 273 correspond to each of a plurality of layers, and each of the interleaving units 273 interleaves a corresponding code bit. Hereinafter, a case in which the layer information transmission unit 270 transmits four layers will be described as an example.

The plurality of coding units 271 code an information bit of a corresponding layer at a certain code rate to generate code bits. For example, when the code rate is 1/2, the plurality of coding units 110 receive 1 information bit by layer and generate two code bits (c_{2,1}, c_{2,2}, c_{3,1}, c_{3,2}, c_{4,1}, c_{4,2}) by layer.

The plurality of interleaving units 273 interleave the code bits (c_{1,1}, c_{1,2}, c_{2,1}, c_{2,2}, c_{3,1}, c_{3,2}, c_{4,1}, c_{4,2}), which have been generated by the corresponding coding units 110, to generate interleaved bits (d_{1,1}, d_{1,2}, d_{2,1}, d_{2,2}, d_{3,1}, d_{3,2}, d_{4,1}, d_{4,2}). Hereinafter, a case in which the interleaving units 273 perform bit-interleaving will be described as an example.

The modulation unit 275 modulates the interleaved bit information to generate modulated symbols. In this case, the modulation unit 275 modulates the interleaved bits (d_{1,1}, d_{1,2}, d_{2,1}, d_{2,2}, d_{3,1}, d_{3,2}, d_{4,1}, d_{4,2}) according to a modulation scheme to generate modulated symbols. The modulation unit 275 may perform mapping by using a coset leader generation matrix in the form of gray mapping. For example, the modulation unit 275 may classify the L number of layers into a plurality of layer groups such that one layer group includes at least two layers, and modulate the interleaved bit information corresponding to each of the layer groups to generate modulated symbols corresponding to each of the layer groups. In this case, the modulated symbols corresponding to each of the layer groups are generated by combining a plurality of symbols for a multi-dimensional modulation. The number of layers included in the respective layer groups may vary depending on a modulation scheme and the number of input bits of the modulation unit 275. For example, when the layer information transmission unit 270 transmits four layers, the modulation unit 275 may group two lower layers, among the four layers, to classify them into one layer group, and group the other two remaining upper layers to classify them into another layer group, and modulates them. The modulated symbols generated thusly may be two QPSK (Quadrature Phase-Shift Keying) symbol-combined four-dimensional modulated symbols.

The plurality of gain control units 277 control the gain of the corresponding modulated symbols. When the plurality of gain control units 277 receives a control signal for changing transmission power of a particular layer from the determining unit 230, they change transmission power by controlling the gain of a corresponding layer. For a layer not retransmitted, the gain control units 277 may set its gain as 0 so as not to retransmit the corresponding layer.

The adding unit 279 adds the gain-controlled modulated symbols to generate a retransmission signal (s). In this case, the retransmission signal (s) may be, for example, two consecutive 16QAM signals.

The layer information transmission unit 270 may transmit the retransmission signal (s) by using two radio resources through one antenna.

The layer information transmission unit 270 of the retransmission apparatus 200 has been described, and the base station 100 may also transmit a plurality of layers in the same manner.

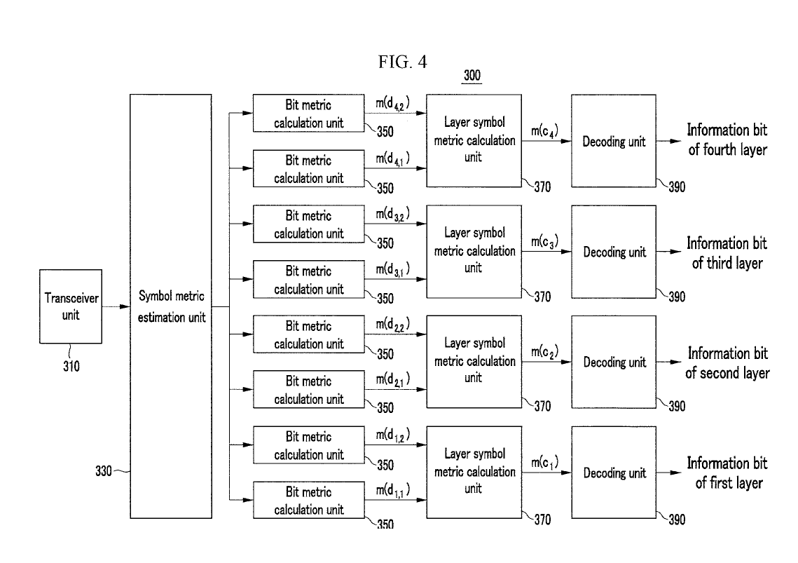

FIG. 4 is a view illustrating a reception apparatus according to an exemplary embodiment of the present invention.

With reference to FIG. 4, the reception apparatus 300 includes a transceiver unit 310, a symbol metric estimation unit 330 for estimating a symbol metric transmitted from the base station 100 and the retransmission apparatus 200, a plurality of bit metric calculation units 350 for calculating a bit metric based on an estimated symbol metric, a plurality of layer symbol metric calculation units 370 for calculating a symbol metric of a corresponding layer based on the bit metric, and a plurality of decoding units 390 for decoding an information bit of the corresponding layer based on the symbol metric of the corresponding layer.

The transceiver unit 310 receives information regarding a plurality of layers from the base station 100 and receives retransmitted layer information from the retransmission apparatus 200. The transceiver unit 310 transmits feedback information related to a retransmission to the retransmission apparatus 200, and receives retransmission control information from the retransmission apparatus 200. The retransmission control information includes a retransmission layer and transmission power of the retransmission layer.

First, when the retransmission apparatus 200 retransmits the same information as that of the base station 100, the reception apparatus 300 decodes it as follows.

The symbol metric estimation unit 300 estimates a symbol metric transmitted from the base station 100 and the retransmission apparatus 200 based on the retransmission control information. When the retransmission control information includes information indicating that the plurality of layers are retransmitted as it is, the symbol metric estimation unit 330 estimates a symbol metric based on channel information obtained by adding each channel information of the base station 100 and the retransmission apparatus 200. In this case, the symbol metric estimation unit 330 calculates a symbol metric [M (ŝ)] with respect to an estimated symbol (ŝ) by using a reception signal (y) as represented by Equation 1 shown below, and in this case, the symbol metric [M (ŝ)] is obtained as represented by Equation 2 shown below.

$$\begin{matrix}y = {H}_{B} {s}_{B} + {H}_{R} {s}_{R} + n \\ = ( {H}_{B} + {H}_{R} ) {s}_{B} + n \\ = H {s}_{B} + n\end{matrix} \qquad ( Equation 1 )$$

Here, H_{B} and H_{R} are channel information from the base station 100 and the retransmission apparatus 200, respectively, s_{B} and s_{R} are transmitted signals by the base station 100 and the retransmission apparatus 200, respectively, and n is noise. Because the retransmission apparatus 200 transmits the plurality of received layers as it is, s_{B} and s_{R} are the same.

M(ŝ)=∥y−Hŝ∥²=H(s_{B}−ŝ)+n∥² (Equation 2)

The plurality of bit metric calculation units 350 obtain symbols related to the interleaved bits (d_{1,1}, d_{1,2}, d_{2,1}, d_{2,2}, d_{3,1}, d_{3,2}, d_{4,1}, d_{4,2}) generated by the base station 100 or the retransmission apparatus 200 among the estimated symbol metrics [M (ŝ)], and determine symbols closest to the reception signal, as bit metrics [m(d_{1,1}), m(d_{1,2}), m(d_{2,1}), m(d_{2,2}), m(d_{3,1}), m(d_{3,2}), m(d_{4,1}), m(d_{4,2})] corresponding to the respective interleaved bits. For example, when symbols which can be generated with the respective interleaved bits (d_{i,j}=bε{−1,1}) among the symbol metrics [M (ŝ)] is S_{i,j}^{b}, the bit metric calculation unit 350 can obtain a bit metric having a minimum distance to the reception signal (y), among the symbols S_{i,j}^{b}, which can be generated with the respective interleaved bits (d_{i,j}), as represented by Equation 3 shown below.

$$m ( {d}_{i , j}^{b} ) = {min}_{\hat{s} ∈ {S}_{i , j}^{b}} {‖ y - H \hat{s} ‖}^{2} = {min}_{\hat{s} ∈ {S}_{i , j}^{b}} M ( \hat{s} ) \qquad ( Equation 3 )$$

The plurality of layer symbol metric calculation units 370 obtain a metric [m(c_{i,j}^{b})] of a code bit (c_{i,j}) by deinterleaving the bit metric [m(d_{i,j}^{b})], and calculate a symbol metric [m(cᵢ)] of the corresponding layer.

The symbol metric [m(cᵢ)] of the corresponding layer is obtained as the sum of the metrics of the respective code bits, as represented by Equation 4 shown below:

$$m ( {c}_{i} ) = {\sum }_{j = 1}^{2} m ( {c}_{i , j} ) \qquad ( Equation 4 )$$

The plurality of decoding units 390 decode an information bit of the corresponding layer based on the symbol metric of the corresponding layer.

When the retransmission apparatus 200 retransmits different information from that of the base station 100 in a transmission slot different from a slot in which the base station 100 transmits information, the reception apparatus 300 performs decoding as follows.

When a signal with adjusted transmission power or information regarding some of layers is received from the retransmission apparatus 200, the symbol metric estimation unit 330 estimates symbol metrics (s_{B}, s_{R}) respectively transmitted from the base station 100 and the retransmission apparatus 200 based each channel information of the base station 100 and the retransmission apparatus 200. In this case, the signal (y_{B}) received from the base station 100 is represented by Equation 5 shown below, and the signal (y_{R}) received from the retransmission apparatus 200 is represented by Equation 6 shown below. The symbol metric estimation unit 330 calculates a symbol metric [M (ŝ_{B})] with respect to an estimation symbol (ŝ_{B}) by using the signal (y_{R}) received from the base station, as represented by Equation 7 shown below:

Also, the symbol metric estimation unit 330 calculates a symbol metric [M (ŝ_{R})] with respect to an estimation symbol (ŝ_{R}) by using the signal (y_{R}) received from the retransmission apparatus 200, as represented by Equation 8 shown below:

y_{B}=H_{B}s_{B}+n_{B} (Equation 5)

y_{R}=H_{R}s_{R}+n_{R} (Equation 6)

Here, H_{B} and H_{R} are channel information of the base station 100 and the retransmission apparatus 200, respectively, s_{B} and s_{R} are transmitted signals by the base station 100 and the retransmission apparatus 200, respectively, and n is noise. Because the retransmission apparatus 200 retransmits information different from that of the base station 100, s_{R} and s_{B} are not the same.

M(ŝ_{B})=∥y_{B}−H_{B}ŝ_{B}∥²=∥H_{B}(s_{B}−ŝ_{B})+n_{B}∥² (Equation 7)

M(ŝ_{R})=∥_{R}−H_{R}ŝ_{R}∥²=∥H_{R}(s_{R}−ŝ_{R})+n_{R}∥² (Equation 8)

As described above, the plurality of bit metric calculation units 350 determines bit metrics corresponding to the interleaved bits (d_{i,j}) based on the estimated symbol metrics [M (ŝ_{B}), M (ŝ_{R})] estimated by the symbol metric estimation unit 330. The bit metrics [m(d_{B,i,j}^{b}), m(d_{B,i,j}^{b})] calculated respectively based on the estimated symbol metrics [M (ŝ_{B}), M (ŝ_{R})] are represented by Equation 9 shown below:

$$m ( {d}_{B , i , j}^{b} ) = {min}_{\hat{s} ∈ {S}_{i , j}^{b}} {‖ {y}_{B} - {H}_{B} {\hat{s}}_{B} ‖}^{2} = {min}_{\hat{s} ∈ {S}_{i , j}^{b}} M ( {\hat{s}}_{B} ) \\ m ( {d}_{R , i , j}^{b} ) = {min}_{\hat{s} ∈ {S}_{i , j}^{b}} {‖ {y}_{R} - {H}_{R} {\hat{s}}_{R} ‖}^{2} = {min}_{\hat{s} ∈ {S}_{i , j}^{b}} M ( {\hat{s}}_{R} ) \qquad ( Equation 9 )$$

The plurality of bit metric calculation units 350 selects one of bit metrics [m(d_{B,i,j}^{b}), m(d_{B,i,j}^{b})] corresponding to the interleaved bits (d_{i,j}), with respect to a layer repeatedly transmitted by the base station 100 and the retransmission apparatus 200. In this case, the bit metric calculation unit 350 determines the reliability of the respective bit metrics [m(d_{B,i,j}^{b}),m(d_{B,i,j}^{b})] as represented by Equation 10 shown below, and selects bit metrics [m(d_{B,i,j}^{b})/m(d_{B,i,j}^{b})] having a high reliability. For example, the reliability of the bit metric [m(d_{B,i,j}^{b})] may be a difference between the bit metrics [m(d_{B,i,j}⁺¹),m(d_{B,i,j}⁻¹)] corresponding to a value (b, bε{−1,1}) the interleaved bit (d_{B,i,j}^{b}) may have.

m(d_{i,j}^{b})=m(d_{B,i,j}^{b}) if |m(d_{B,i,j}⁺¹)−m(d_{B,i,j}⁻¹)|>|m(d_{B,i,j}⁺¹)−m(d_{B,i,j}⁻¹)|

m(d_{i,j}^{b})=(d_{B,i,j}^{b}) if |m(d_{B,i,j}⁺¹)−m(d_{B,i,j}⁻¹)|<|m(d_{B,i,j}⁺¹)−m(d_{B,i,j}⁻¹)| (Equation 10)

As described above, the plurality of layer symbol metric calculations 370 deinterleave the bit metric [m(d_{i,j}^{b})] determined by the bit metric calculation units 350 to obtain a metric [m(c_{B,i,j}^{b})] of the code bit (c_{i,j}), and calculate the symbol metric [m(cᵢ)] of the corresponding layer.

The decoding units 390 decode an information bit of the corresponding layer based on the layer symbol metric.

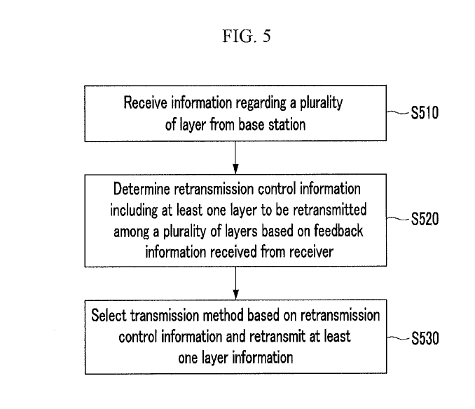

FIG. 5 is a flow chart illustrating the process of a retransmission method according to an exemplary embodiment of the present invention.

With reference to FIG. 5, the retransmission apparatus 200 receives information regarding a plurality of layers from the base station 100 (S510).

The retransmission apparatus 200 determines retransmission control information including at least one layer to be retransmitted among the plurality of layers based on feedback information received from the reception apparatus 300 (S520). In this case, the feedback information includes information regarding a layer requested to be retransmitted by the reception apparatus 300 and the retransmission control information includes the information regarding the layer to be retransmitted and information regarding transmission power of the layer to be retransmitted.

The retransmission apparatus 200 selects a transmission scheme based on the retransmission control information and retransmits information regarding at least one layer to the reception apparatus 300 (S530). The transmission scheme may differ depending on the information regarding the layer to be retransmitted and the information regarding the transmission power of the layer to be retransmitted. When the retransmission apparatus 200 retransmits some of the plurality of layers, it transmits a signal such that the reception apparatus 300 can distinguish (or identify) signals transmitted the base station 100 and the retransmission apparatus 200. Namely, the retransmission apparatus 200 retransmits information regarding some layers to the reception apparatus 300 in a transmission slot different from that in which the information regarding the plurality of layers is received from the base station. Similarly, in case of adjusting transmission power of the layer to be retransmitted and retransmitting the layer, the retransmission apparatus 200 retransmits information regarding some of the layers to the reception apparatus 300 in a transmission slot different from that in which the information regarding the plurality of layers is received from the base station 100. However, in case in which the retransmission apparatus 200 transmits a signal, which has been received from the base station 100, as it is, because the signals transmitted by the base station 100 and the retransmission apparatus 200 are the same, the reception apparatus 300 can obtain a diversity gain although the signals are mixed. Thus, in case in which the retransmission apparatus 200 transmits the signal, which has been received from the base station 100, as it is, the retransmission apparatus 200 retransmits the information regarding the plurality of layers to the reception apparatus 300 in the same transmission slot as that in which the information regarding the plurality of layers is received from the base station 100.

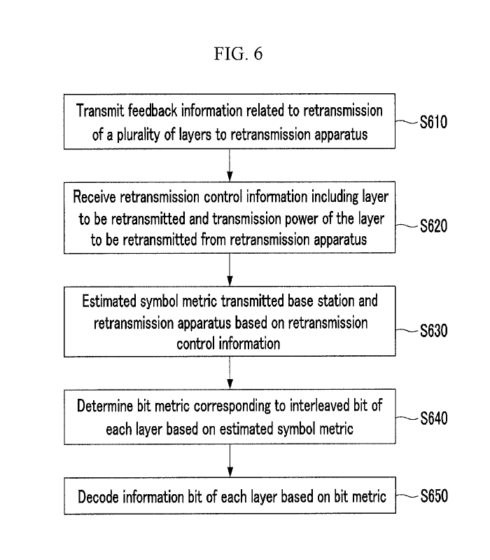

FIG. 6 is a flow chart illustrating the process of a reception method according to an exemplary embodiment of the present invention.

With reference to FIG. 6, the reception apparatus 300 transmits feedback information related to a retransmission of a plurality of layers to the retransmission apparatus 200 (S610). In this case, the reception apparatus 300 may include information regarding a layer requested to be retransmitted in the feedback information and transmit the same.

The reception apparatus 300 receives retransmission control information including the layer to be retransmitted and transmission power of the layer to be retransmitted from the retransmission apparatus 200 (S620).

The reception apparatus 300 estimates symbol metrics transmitted from the base station 100 and the retransmission apparatus 200 based on the retransmission control information (S630). In this case, if the retransmission control information includes information indicating that a signal different from that of the base station 100 is retransmitted, the reception apparatus 300 estimates symbol metrics transmitted from the base station 100 and the retransmission apparatus 200 based on each of channel information of the base station 100 and the retransmission apparatus 200.

The reception apparatus 300 determines a bit metric corresponding to an interleaved bit of each layer based on the estimated symbol metric (S640). When the reception apparatus 300 receives the same layer repeatedly from the base station 100 and the retransmission apparatus 200, the reception apparatus 300 selects one of bit metrics of the respective base station 100 and the retransmission apparatus 200. In this case, the reception apparatus 300 may select the bit metric upon discriminating the reliability of each of the bit metrics as shown in Equation 10 above.

The reception apparatus 300 decodes an information bit of each layer based on the bit metric (S650). In this case, in order to obtain a symbol metric of each layer required for the decoding operation, the reception apparatus 300 deinterleaves the bit metric to use a metric of a code bit.

As described above, according to an exemplary embodiment of the present invention, because the retransmission apparatus 200 retransmits some of layers according to the situation of the reception apparatus, power consumption can be reduced. In addition, the retransmission apparatus 200 can separately adjust coverage of each layer by regulating transmission power of each layer and reduce power consumption. Also, because the reception apparatus 300 receives only information regarding a layer required to be retransmitted, it can effectively decode it to obtain layer information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A retransmission apparatus for retransmitting information received from a base station to a reception apparatus, the apparatus comprising:
a reception unit configured to receive information regarding a plurality of layers from the base station;
determining unit configured to determine retransmission control information including at least one layer to be retransmitted among the plurality of layers based on feedback information received from the reception apparatus; and
a transmission unit configured to retransmit the at least one layer information to the reception apparatus based on the results of the determining unit.

2. The apparatus of claim 1, wherein the determining unit determines the retransmission control information based on the feedback information including layer information requested to be retransmitted.

3. The apparatus of claim 1, wherein when it is determined to retransmit some of a plurality of layers, the transmission unit retransmits information regarding some of the layers to the reception apparatus in a transmission slot different from a slot in which the information regarding the plurality of layers is received from the base station.

4. The apparatus of claim 1, wherein when it is determined to retransmit the plurality of layers, the transmission unit retransmits the information regarding the plurality of layers to the reception apparatus in the same transmission slot in which the information regarding the plurality of layers is received from the base station.

5. The apparatus of claim 1, wherein the retransmission control information comprises transmission power of the layer to be retransmitted.

6. The apparatus of claim 5, wherein when it is determined to change transmission power of the layer to be retransmitted, the transmission unit retransmits the information regarding the layer to be retransmitted to the reception apparatus in a transmission slot different from a slot in which the information regarding the plurality of layers is received from the base station.

7. The apparatus of claim 1, further comprising:
a retransmission control information transmission unit configured to transmit the retransmission control information to the reception apparatus before retransmitting the at least one layer information to the reception apparatus.

8. A reception apparatus for receiving information regarding a plurality of layers from a base station and receiving at least one of layer information among the plurality of layers from a retransmission apparatus, the apparatus comprising:
a transceiver unit configured to transmit feedback information related to a retransmission of the plurality of layers to the retransmission apparatus and receive retransmission control information from the retransmission apparatus;
a symbol metric estimation unit configured to estimate symbol metrics transmitted from the base station and the retransmission apparatus based on the retransmission control information;
a plurality of bit metric calculation units configured to determine bit metrics of a corresponding layer among the plurality of corresponding layers based on the estimated symbol metrics; and
a decoding unit configured to decode an information bit of the corresponding layer based on the bit metrics of the corresponding layer.

9. The apparatus of claim 8, wherein the retransmission control information comprises a layer to be retransmitted by the retransmission apparatus and transmission power of the layer to be retransmitted.

10. The apparatus of claim 8, wherein when the retransmission control information includes information indicating that the plurality of layers are retransmitted, the symbol metric estimation unit estimates symbol metrics based on channel information obtained by adding channel information of the base station and that of the retransmission apparatus.

11. The apparatus of claim 8, wherein when the retransmission control information includes information indicating that a signal different from that of the base station is retransmitted, the symbol metric estimation unit estimates the symbol metrics transmitted from the base station and the retransmission apparatus based on the channel information of the base station and that of the retransmission apparatus, respectively.

12. The apparatus of claim 11, wherein the transceiver unit receives the retransmission control information including at least one of information indicating that some of the plurality of layers are retransmitted and information indicating that a layer with changed transmission power is retransmitted.

13. The apparatus of claim 11, wherein each of the bit metric calculation unit comprises:
a calculation unit configured to calculate a first bit metric transmitted from the base station and a second bit metric transmitted from the retransmission apparatus based on the estimated symbol metrics; and
a selection unit configured to determine any one of the first and second bit metrics as a bit metric of the corresponding layer based on the reliability of the first and second bit metrics when the base station and the retransmission apparatus transmit the same layer information.

14. A method for retransmitting information received from a base station to a reception apparatus by a retransmission apparatus, the method comprising:
receiving information regarding a plurality of layers from the base station;
determining retransmission control information including at least one layer to be transmitted among the plurality of layers based on feedback information received from the reception apparatus; and
selecting a transmission scheme based on the retransmission control information and retransmitting the at least one layer information to the reception apparatus.

15. The method of claim 14, wherein in the determining of the retransmission control information, the retransmission control information is determined based on the feedback information including layer information requested to be retransmitted.

16. The method of claim 14, wherein the retransmission control information comprises transmission power of the layer to be retransmitted.

17. The method of claim 16, wherein, in the retransmitting,
when it is determined to retransmit some of the plurality of layers, the information regarding some of the layers is retransmitted in a transmission slot different from a slot in which the information regarding the plurality of layers is received from the base station,
when it is determined to retransmit the plurality of layers, the information regarding the plurality of layers is retransmitted in the same slot as the transmission slot in which the information regarding the plurality of layers is received from the base station, and
when it is determined to change transmission power of the layer to be retransmitted, the information regarding the layer to be retransmitted is retransmitted in the transmission slot different from a slot in which the information regarding the plurality of layers is received from the base station.

18. A method for receiving information regarding a plurality of layers from a base station and at least one layer information among the plurality of layers from a retransmission apparatus by a reception apparatus, the method comprising:
transmitting feedback information related to a retransmission of the plurality of layers to the retransmission apparatus and receiving retransmission control information including a layer to be retransmitted and transmission power of the layer to be retransmitted from the retransmission apparatus;
estimating symbol metrics transmitted from the base station and the retransmission apparatus based on the retransmission control information;
determining bit metric of a corresponding layer among the plurality of layers based on the estimated symbol metric; and
decoding an information bit of the corresponding layer based on the bit metric of the corresponding layer.

19. The method of claim 18, wherein, in the estimating of the symbol metrics, when the retransmission control information includes information indicating that a signal different from that of the base station is retransmitted, the respective symbol metrics transmitted from the base station and the retransmission apparatus are estimated based on channel information of the base station and that of the retransmission apparatus.

20. The method of claim 19, wherein the determining of the bit metrics comprises:
calculating a first bit metric transmitted from the base station and a second bit metric transmitted from the retransmission apparatus based on the estimated symbol metrics; and
when the base station and the retransmission apparatus transmit the same layer information, selecting any one of the first and second bit metrics, as the bit metric of the corresponding layer based on the reliability of the first and second bit metrics.
